(19) United States
(12) Patent Application Publication
(10) Pub. No.: US 2009/0146836 A1
(43) Pub. Date: Jun. 11, 2009

(54) METHODS AND APPARATUS TO CONFIGURE DRILL STRING COMMUNICATIONS

(75) Inventors: David Santoso, Sagamihara (JP); Julius Kusuma, Houston, TX (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 11/953,902

(22) Filed: Dec. 11, 2007

(51) Int. Cl. E21B 47/16; G01V 3/18

(52) U.S. Cl. 340/854.4; 367/82

(57) ABSTRACT

Methods and apparatus to configure drillstring communications are described. In one disclosed example, a method to configure drillstring communications involves generating a signal at a transmitter coupled to a drillstring, transmitting the generated signal via the transmitter to a receiver, sampling the transmitted signal at the receiver to generate a received signal, calculating a transmission characteristic based on a comparison of the generated signal and the received signal, and configuring at least one of the transmitter or receiver based on the transmission characteristic.

### FIELD OF THE DISCLOSURE

The present disclosure relates generally to drillstring communications and, more particularly, to methods and apparatus to configure drillstring communications.

### BACKGROUND

Data communications have become increasingly important to effective wellbore drilling and measurement systems. Drill operators are becoming reliant on real-time data related to downhole operations to reduce drilling downtime and increase efficiency. Real-time data is often obtained from measurement-while-drilling (MWD) and logging-while-drilling (LWD) systems, both of which employ some form of telemetry or communication system to transfer data via the drillstring. Such telemetry systems are typically capable of transferring data and commands between the top and bottom of the drillstring.

There are numerous techniques by which telemetry systems can convey signals carrying data and commands. Some known techniques convey electrical signals via wired drillpipe (WDP), acoustic signals via drill pipe, and/or electromagnetic signals via the earth or the drillpipe itself in the case of WDP, each section of drillpipe typically contains a communications coupler at each end and one or more conductors to convey electrical signals carrying data between the communications couplers. Regardless of the type of drillstring telemetry system employed, communication via a drillstring typically involves the transmission of signals over relatively large distances. Repeaters may be used in some drillstring telemetry systems to facilitate the transmission of signals over these relatively large distances. In WDP telemetry systems, repeaters are typically located every few thousand feet along the drillstring. A typical interval is between 80 and 100 pipe lengths, or about 2,400 feet to 3,000 feet.

The signal conditioning or communications circuitry used in telemetry modules and/or repeaters is often selected (or designed) based on the estimated transmission characteristics of the communication medium and/or transmission channel (e.g., signal path) through which the telemetry signals are to he sent. One known method of estimating the transmission characteristics of a drillstring telemetry system communication medium and/or transmission channel involves characterizing a part of a medium or transmission channel at the earth surface and using these surface measurements to estimate the in situ transmission characteristics of the entire communication medium or transmission channel. For example, one known method of characterizing a WDP communications or transmission channel measures the z-parameters of one WDP pipe segment using a network analyzer on the surface, calculates the transmission parameters from the z-parameters, and mathematically extrapolates the measurements to an entire stack of WDP (i.e., a drillstring).

However, different sections of a drillstring may experience different environmental conditions due to changes in depth, pressure, temperature, mechanical shock, and resistivity of surrounding rock formations along the length of the wellbore. These different conditions may cause different signal propagation, noise, and attenuation characteristics between sections of drillpipe. Although, signal processing could compensate for some of these differences, the power and space restrictions within telemetry systems (e.g., downhole telemetry modules, repeaters, etc.) provide only limited signal processing capabilities. Additionally, the environmental conditions affecting a particular section of drillstring may change over time as the drillstring penetrates a formation. As a result, the transmission characteristics estimates made at an initial time can quickly become inaccurate.

### SUMMARY

In one disclosed example, a method to configure drillstring communications involves generating a signal at a transmitter coupled to a drillstring, transmitting the generated signal via the transmitter to a receiver, sampling the transmitted signal at the receiver to generate a received signal, calculating a transmission characteristic based on a comparison of the generated signal and the received signal, and configuring at least one of the transmitter or receiver based on the transmission characteristic.

In another disclosed example, a system to configure drillstring communications includes a processing system having a memory and a processor. The processor is to receive first information corresponding to a signal transmitted via a transmitter along a drillstring and second information corresponding to a receiver receiving the signal transmitted along the drillstring, calculate a transmission characteristic of the drillstring communications based on a comparison of the first and second information, and configure at least one of the transmitter or the receiver based on the transmission characteristic.

In yet another disclosed example, a machine readable medium has instructions stored thereon that, when executed, cause a machine to receive first information corresponding to a signal transmitted via a transmitter along a drillstring and second information corresponding to a receiver receiving the signal transmitted along the drillstring, calculate a transmission characteristic of the drillstring communications based on a comparison of the first and second information, and configure at least one of the transmitter or the receiver based on the transmission characteristic.

### BRIEF DESCRIPTION OF THE DRAWINGS

FIG. 1 illustrates an example wellsite system having a wired drillpipe telemetry system that employs the example drillstring communication configuration methods and apparatus described herein.

FIG. 2 is a detailed schematic diagram of example signal processing systems that may be used to implement the example telemetry modules and repeaters of FIG. 1.

FIG. 3 is a flowchart representative of an example method to reconfigure a downhole drillstring telemetry or communication channel.

FIG. 4 is a more detailed flowchart representative of an example method to measure and configure the transmission characteristics of a drillstring telemetry or communication channel.

FIG. 5 is a flowchart representative of an example method to configure a portion of a drillstring telemetry or communication channel when added to the drillstring.

FIG. 6 is a block diagram of an example computing system that may he used to implement the example methods and apparatus described herein.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness. Although the following discloses example systems including, among other components, software or firmware executed on hardware, it should be noted that such systems are merely illustrative and should not be considered as limiting. For example, it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. Accordingly, while the following describes example systems, persons of ordinary skill in the art will readily appreciate that the examples are not the only way to implement such systems.

The example methods and apparatus described herein can be used to measure, characterize, and configure a drillstring telemetry or communication system of the type used in downhole drilling and/or measurement operations. The example methods and apparatus described herein may be used to individually configure one or more telemetry modules and/or repeaters based on the transmission characteristics associated with the different portions of the drillstring telemetry or communication channel through, which those telemetry modules and/or repeaters communicate. By measuring the transmission characteristics of different portions of a drillstring telemetry or communication channel and individually configuring the associated telemetry modules and/or repeaters, the quality and/or efficiency of communications via each portion of the telemetry or communication channel can be increased, thereby increasing the overall quality and/or efficiency of communication via the drillstring. As a result, faster data transmission, lower error rates, and/or lower power consumption may be achieved with a given drillstring telemetry or communication system.

As described in greater detail below, the example methods and apparatus to configure drillstring communications can be advantageously used with MWD and/or LWD operations to dynamically configure or reconfigure the telemetry modules and/or repeaters spaced along the drillstring. More specifically, as the transmission characteristics of the drillstring telemetry or communication channel vary due to, for example, changes in the depth at which the drillstring is operating and/or over time, the configurations of the telemetry modules and/or repeaters can be adjusted to compensate for the changes to maintain efficient, high-quality communications (e.g., transmission of operational data). Such dynamic configuration or reconfiguration may be performed periodically and/or in response to a decrease in the quality of drillstring communications below a selected level.

In one described example, a wired drillpipe telemetry or communication channel having a transmitter and a receiver is measured using a known reference signal, such as a sine wave, a chirp signal or quadrature phase-shift keying pseudorandom bits. The reference signal may also be replaced by operational data such as, for example, data generated as part of drilling or measurement operations. The reference signal is transmitted by the transmitter through the channel (either uphole or downhole) or a portion of the channel (e.g., a set of drillpipe between repeaters) and is measured (e.g., digitally sampled) at the receiver, which may be in another telemetry module or repeater spaced along the drillstring. Data representing a transmitted reference signal and a received signal (i.e. the reference signal after it has passed through at least a portion of the drillstring telemetry or communication system) are transmitted to a computer or processing unit located at the surface. The surface-based computer or processing unit compares the signals (e.g., by comparing data representing the signals) and calculates the transmission characteristics of the channel using signal processing techniques. The surface computer then sends appropriate configuration information (e,g., a configuration file, equalizer coefficients, etc.) to the transmitter and/or the receiver to configure the transmitter and/or receiver based on the transmission characteristics of the channel portion through which the transmitter and receiver communicate. The configuration information may result in a change of the carrier frequency, modulation type, bandwidth and/or equalization of one or more telemetry modules and/or repeaters.

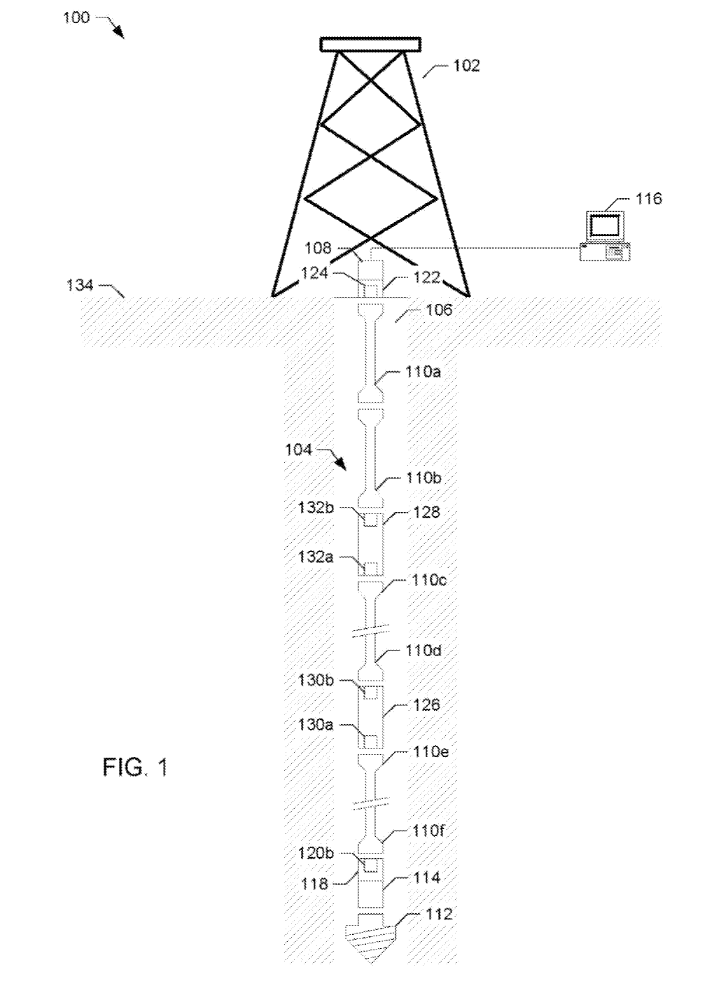

FIG. 1 depicts an example wellsite system 100 employing the example drillstring communications configuration apparatus and methods described herein. In particular, a land-based rig 102 deploys a drillstring 104 in a wellbore or borehole 106. The drillstring 104 includes a Kelly or topdrive 108 to rotate the drillstring 104, a plurality of drillpipe sections or sets 110a-f, and a bit 112. To measure drilling conditions near the bit 112, control the operation of the drillstring 104 and, particularly, the bit 112, the drillstring 104 also includes a bottom hole assembly 114 (BHA). The BHA 114 may include a variety of sensors, for example, to measure or monitor drilling conditions near the bit 112.

To provide communications between the BHA 114 and a surface computer 116, the BHA 114 may include a telemetry module 118 having a transceiver 120b that communicates with a surface-based telemetry module 122 having another transceiver 124, which may be located in the kelly or topdrive 108. In addition, to enable the drillstring communication signals to have sufficient strength and quality throughout the length of the drillstring 104, one or more repeaters 126 and 128 may be located along the drillstring 104 between the BHA 114 and the kelly or topdrive 108. In the example of FIG. 1, the repeaters 126 and 128 include respective pairs of transceivers 130a-b and 132a-b, thereby enabling two-way (i.e., uphole and/or downhole) communications between the surface computer 116, the transceiver 120b in the BHA 114 and the transceiver 124 in the kelly or topdrive 108. However, in other examples, one-way (e.g., uphole only) communications may be provided instead. In those examples, the BHA 114 may include a transmitter, each of the repeaters 126 and 128 may include a transmitter to transmit communication signals uphole and a receiver to receive signals transmitted uphole from the BHA 114 transmitter and/or another repeater downhole from that repeater. In still other examples, one-way communications downhole may be provided.

The telemetry or communications channel between the telemetry modules 118 and 122 and the repeaters 126 and 128 along the drillstring 104 may he implemented using wired drillpipe (WDP), in which case electrical signals are conducted through the drillpipe sections or sets 110a-f, acoustic signals transmitted through the drillpipe sections or sets 110a-f, and/or electromagnetic signals, in which case signals travel through the earth. For purposes of clarity, the example of FIG. 1 is described, as being implemented using WDP. An example of wired drill pipe is disclosed in U.S. Patent Application Publication No. 2006/0225926 by Madhavan, et al., which is incorporated herein by reference in its entirety. However, it should be understood that any other type of transmission channel and/or medium could be used without departing from the spirit of the examples described herein.

Thus, the drillstring communications channel of the example in FIG. 1 enables the surface computer 116 to communicate with the BHA 114 during drilling operations to better control drilling efficiency, prevent damage to the bit 112, etc. In particular, information concerning the downhole conditions near the bit 112 can be sent uphole via the transceiver 120b of the BHA 114, the transceivers 130a-b and 132a-b of the repeaters 126 and 128, and the transceiver 124 of the kelly or topdrive 108. The downhole condition information received by the surface computer 116 may be processed and, if needed, control information may be provided to an operator, who may adjust drilling operations at the surface 134, and/or may send commands via the transceivers 120b, 124, 130a-b and 132a-b and the WDP 110a-f making up the drillstring 104, to the BHA 114, which may adjust drilling operations to improve drilling efficiency and/or prevent damage to the bit 112.

In contrast to known drillstring telemetry or communication systems, the telemetry modules 118 and 122 and/or the repeaters 126 and 128 of the example drillstring 104 can be individually configured based on the transmission characteristics of the portion of the drillstring transmission channel through which those telemetry modules and/or repeaters communicate. For example, a reference signal may be generated in the telemetry module 118 of the BHA 114 and transmitted uphole via the conductors in the WDP 110a-f of the drillstring 104. The generated signal may be a digitally generated sine wave, chirp signal, or any other desired reference signal that is converted to an analog signal for transmission uphole by a transmitter portion of the transceiver 120b in the BHA 114. Other signals representing operational data (i.e., data generated as a part of drilling or measurement operations) may also be used as an alternative to a reference signal to measure the characteristics of the drillstring telemetry or communications channel. Operational data may include data generated by sensors located in the BHA 114 or one of the repeaters 126 and 128, command data generated by an operator terminal, or configuration information generated by the surface computer 116. Using signals representing operational data enables measurement of the drillstring telemetry or communications channel characteristics without pausing the flow of operational data (e.g., during drilling operations). In any event the transmitted generated signal (e.g., the converted analog signal) is conducted to the repeater 126 via the WDP sections or set of drillpipes 110a-f. A receiver portion of the transceiver 130a in the repeater 126 receives the signal sent by the telemetry module 118 in the BHA 114 and digitally samples the received signal to convert it into digital data corresponding to the received signal. The digital data corresponding to the reference signal sent uphole by the transceiver 120b in the telemetry module 118 and the digital data corresponding to the signal received by the repeater 126 are then sent uphole to the surface computer 116 via the transceiver 130b, the WDP sections 110c-d, the repeater 128, the WDP sections 110a-b, and the telemetry module 122 using any desired communication protocol.

The surface computer 116 then compares the reference signal sent by the telemetry module 118 of the BHA 114 and the signal received by the repeater 126 by comparing the digital data representing these signals. One or more transmission characteristics (e.g., an attenuation, phase-shift, etc) of the portion (e.g., the drillpipe sets or sections 110e-f) of the drillstring telemetry channel between the BHA 114 and the repeater 126 are then calculated based on the comparison. These one or more transmission characteristics are then used to generate configuration information (e.g., equalizer parameters, modulation frequencies, etc.) that is sent downhole to the repeater 126 and/or the BHA 114 to configure the transmitter in the BHA 114 and/or the receiver in the repeater 126 based on the transmission characteristic(s) calculated by the surface computer 116. In this manner, the quality and efficiency of the communications between the BHA 114 and the repeater 126 can be increased or optimized for the particular transmission characteristics of the portion of the drillstring telemetry or communication channel between the BHA 114 and the repeater 126.

The foregoing drillstring communications configuration technique can be used to configure other transmitters and receivers communicating through other sections or sets of WDP along the drillstring 104. Additionally, the transmission characteristics for uphole and downhole communications may be calculated separately to enable independent optimization of downhole and uphole communications along the drillstring 104. For example, the transceiver 130a of the repeater 126 may be configured so that its transmitter portion is optimized for downhole communications with the telemetry module 118 in the BHA 114 and the receiver portion is optimized for receiving uphole communications from the telemetry module 118 of the BHA 114. Likewise, the transceiver 130b of the repeater 126 may be configured so that its transmitter and receiver portions are individually configured to optimize the communications uphole to and receipt of downhole communications from the repeater 128. Thus, using the example techniques described herein, the surface computer 116 may perform four separate analyses to calculate the transmission characteristics and appropriate configuration information for uphole and downhole communications by each of the transceivers 130a-b of the repeater 126.

Further, the example drillstring communication configuration techniques described herein may be used to configure or reconfigure transmitters, receivers, transceivers, etc. used to implement the repeaters 126 and 128 and the telemetry modules 118 and 122 making up the drillstring telemetry or communications system in response to a reduction in the quality of drillstring communications and/or after a certain maximum amount of time has elapsed. Such configuration or reconfiguration enables drillstring communications to be optimized as the transmission characteristics of the portions of the telemetry or communications channel associated with communicatively linked transceivers (i.e., transceivers communicating at a distance along the drillstring) change over time. For example, as drilling progresses, the changing depth, length of the drillstring 104, changes in wellbore physical properties, electrical interference, etc. may change, thereby changing transmission characteristics along the drillstring 104. Additionally, while the example of FIG. 1 is described as being implemented using a drillstring utilizing WDP, it should he understood that the principles described in connection with this example can be more generally applied and, thus, may be applied to any type of downhole tool and/or any type of communications including, for example, electromagnetic communications, acoustic communications, etc.

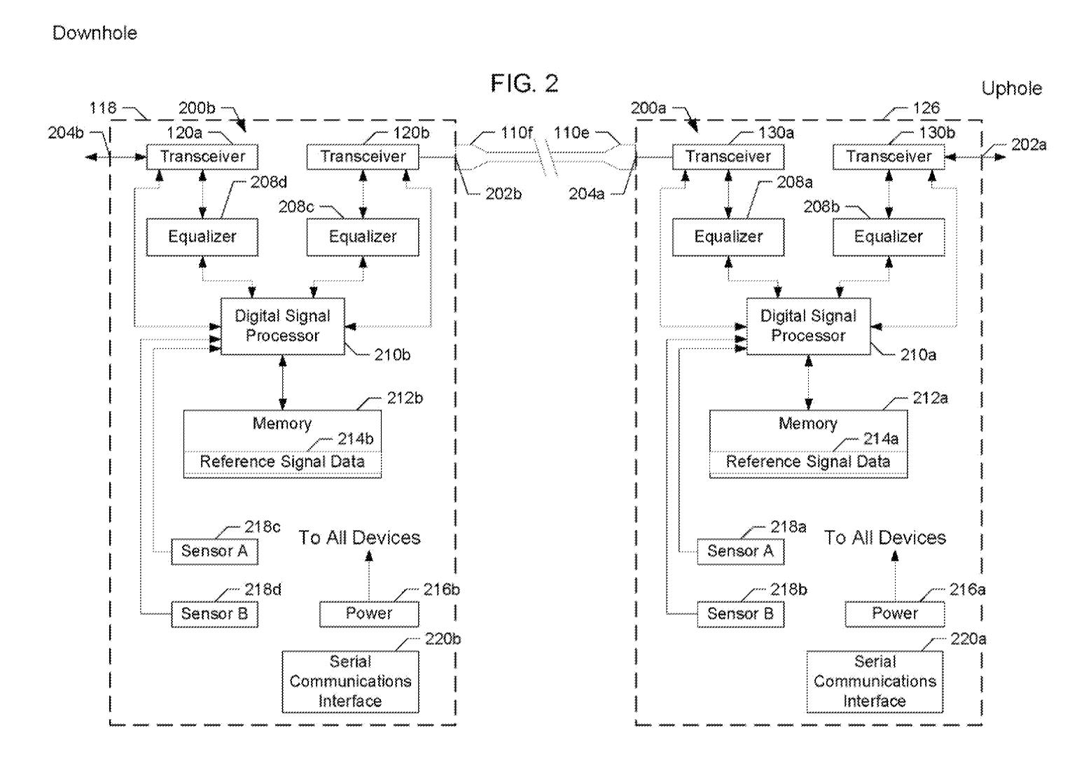

FIG. 2 is a detailed schematic diagram of example signal processing systems 200a-b that may be used to implement the example telemetry modules 118 and 122 and the example repeaters 126 and 128 of FIG. 1. The example signal processing system 200a may have two communication ports, each of which may be able to transmit and receive data. In particular, an uphole communication port 202a communicatively couples the signal processing system 200a to a transmitter or receiver located uphole and a downhole communication port 204a communicatively couples the signal processing system 200a to a transmitter or receiver located downhole. Alternatively, the uphole communication port 202a and the downhole communication port 204a may be communicatively coupled to transceivers located uphole and downhole, respectively.

To perform uphole communications, the signal processing system 200a includes the transceiver 130b, which is coupled to the uphole communication port 202a and a signal equalizer 208b. The downhole communication port 204a is coupled to the other transceiver 130a, which is coupled to another signal equalizer 208a. The transceivers 130a-b send signals to receivers and receive signals from transmitters via the ports 202a and 204a and the drillstring telemetry or communication channel. While the transceivers 130a-b are depicted as single blocks, the transceivers 130a-b may be implemented using separate transmitters and receivers.

The signal equalizers 208a-b may be programmed to condition a transmitted or received signal according to a set of equalization coefficients. Such signal conditioning may reduce the presence of certain undesirable transmission characteristics such as, for example, high attenuation of the carrier frequency, low signal-to-noise ratio, limited channel bandwidth, phase delays, etc. Such signal conditioning can also amplify desirable signals and/or signal characteristics.

In the example signal processing system 200a, the equalizers 208a-b are coupled to a digital signal processor 210a, which amplifies a signal, performs analog-to-digital or digital-to-analog conversion or other known digital signal processing or logic on the signal, programs the equalizers 208a-b and/or the transceivers 206a-b, and/or receives input data from one or more sensors 218a-b.

The digital signal processor 210a may also store data in or retrieve data from a memory 212a, which may be implemented using any desired combination of volatile and/or non-volatile memory, including but not limited to random-access memory (RAM), read-only memory (ROM) or flash memory. In one example, the memory 212a includes non-volatile flash memory to store reference signal data 214a and also includes RAM for fast-access memory. The reference signal data 214a may include data representative of a combination of several sine waves, a chirp signal, any digital modulation, and/or other signals having time-frequency distributions. A sine wave reference signal may be at a single frequency of interest or may include a plurality of signals using a plurality of carrier frequencies, a chirp signal has an increasing or decreasing time-frequency distribution, and an encoded/modulated set of bits, which may be spread over time and frequency simultaneously within its selected band of transmission.

Additionally, the memory 212a may store one or more sets of configuration data or information. For example, the configuration data or information may include two sets of transmit configuration data and two sets of receive configuration data. Each set of configuration data may be distinct or may be equal to other sets. One set of transmit configuration data and one set of receive configuration data are associated with the equalizer 208b and the other two sets are associated with the equalizer 208a. These data sets may be updated by the surface computer 116 using the drillstring communications configuration methods described herein. In particular, the digital signal processor 210a may obtain data from the memory 212a to program or configure the equalizers 208a-b and/or may store data in the memory 212a in response to a configuration or reconfiguration of the signal processing system 200a.

It should be appreciated that the example signal processing system 200b may be structurally and/or functionally similar or identical to the described signal processing system 200a. However, as implemented in the example telemetry modules 118 and 122, the signal processing system 200b may have only one of the uphole or downhole communication ports 202b or 204b communicatively coupled to the drillstring telemetry system. In that case, the signal processing system 200b may replace the unutilized port 202b or 204b with a port coupled to, for example, the BHA 114, the kelly or topdrive 108, or the surface computer 116. In such a case, a transceiver 120a coupled to the unutilised port 202b or 204b may be omitted from the signal processing system 200b or used to communicate with another device coupled to the unutilized port 202b or 204b. The transceiver 120a may be coupled to an equalizer 208d.

To better understand the operation of the example signal processing systems 200a-b, the operation of the systems 200a-b will be described in connection with the example system of FIG. 1. In particular, for purposes of discussion, each of the telemetry modules 118 and 122 and the repeaters 126 and 128 are assumed to include a signal processing system similar or identical to the example systems 200a-b of FIG 2.

Turning now to the example described above in connection with FIG. 1, the signal processing system 200b in the telemetry module 118 generates a reference signal by obtaining or retrieving reference signal data 214b from a memory 212b. In particular, a digital signal processor 210b may obtain the desired reference signal data 214b from the memory 212b and convert, the digital data representative of the reference signal into an analog signal representation of the reference signal data 214b. The reference signal data 214b (and its analog form) may be representative of a sine wave, chirp signal, or any other desired reference signal that may be used to characterize a communication channel. The digital signal processor 210b then passes the analog representation, of the reference signal to the uphole transceiver 120b via equalizer 208c. The equalizer 208c may condition the analog representation of the reference signal according to a set of programmed coefficients. Depending on the type of channel characterization desired, the equalizer 208c may be instructed (e.g., by the digital signal processor 210b) to not perform any signal conditioning to enable more accurate measurement of the telemetry or communication channel characteristics. Alternatively, the equalizer 208c may be instructed to perform signal conditioning to measure certain characteristics of the telemetry or communication channel. The transceiver 120b then modulates the conditioned (e.g., equalized) analog representation of the reference signal and transmits the analog signal uphole via the uphole communications port 202b, the WDP sections 110e-f to the repeater 126.

In the example signal processing system 200a of the repeater 126, the downhole transceiver 130a receives the analog signal via the downhole port 204a. The received analog signal is passed to the equalizer 208a, which may perform signal conditioning, and the conditioned signal is then passed to the digital signal processor 210a. Depending on the type of channel characterization desired, the equalizer 208a may be instructed to not perform any signal conditioning. Alternatively, the equalizer 208a may be instructed to perform signal conditioning to measure certain characteristics of the telemetry or communication channel. The digital signal processor 210a then samples the received analog signal to generate digital data representative of the received analog signal.

The signal processing system 200b in the telemetry module 118 then transmits the reference signal data 214b to the surface computer 116 and the repeater 126 transmits the corresponding received signal data, to the surface computer 116 via the WDP sections 110a-d, the repeater 128, the telemetry module 122 and the kelly or topdrive 108, and the reference signal data is additionally transmitted through the WDP sections 110e-f and the repeater 126. Alternatively, the reference signal data 214b may not be transmitted to the surface computer 116 if this data has been previously stored in the surface computer 116.

At the surface computer 116, the reference signal data and the received signal data are received and analyzed or compared to calculate one or more transmission characteristics of the WDP sections 110e-f, which make up the portion of the drillstring telemetry or communication channel between the telemetry module 118 and the repeater 126. After calculating the transmission characteristics, the surface computer 116 may generate one or more configuration files containing or information relating to, for example, a carrier frequency, a modulation scheme, bandwidth, a phase delay, equalizer coefficients, and/or other information. The surface computer 116 may transmit the one or more configuration files or configuration information to the repeater 126 and/or the telemetry module 118 via the same medium (e.g., via WDP sections 110e-f) used to transmit the reference signal data 214b and received signal data to the surface computer 116.

The configuration files or information is received by one or both of the transceivers 130b and 120b and is passed to respective ones of the digital signal processors 210a-b via respective ones of the signal equalizers 208a and/or 208c. When received, the digital signal processors 210a-b read their configuration files and configure the appropriate ones of the transceivers 130a-b and 120b and/or equalizers 208a-c according to the configuration information therein, in this example, the digital signal processor 210a in the repeater 126 configures (or reconfigures) the transceiver 130a and the equalizer 208a associated with the downhole port 204a in the repeater 126 and the digital signal processor 210b in the telemetry module 118 configures (or reconfigures) the transceiver 120b and the equalizer 208c associated with the uphole port 202b in the telemetry module 118. However, if it is assumed or known that the transmission characteristics in the uphole direction are substantially the same as or similar to the transmission characteristics in the downhole direction for that portion of the drillstring telemetry channel, the transceiver 120b and the equalizer 208c in the telemetry module 118 and the transceiver 206a and the equalizer 208a in the repeater 126 may also be configured or reconfigured by their respective digital signal processors 210a-b using the same configuration file or information.

In normal drilling operations, during which the drillstring telemetry or communication channel is communicating signals representing operational data, the transceiver 130a coupled to the downhole communication port 204a in the repeater 126 receives operational data (e.g., data from the transceiver 118 located in the telemetry module of the BHA 114). The transceiver 130a passes the signal to the digital signal processor 210a via the equalizer 208a, which processes the signal according to the configuration of the equalizer 208a. The digital signal processor 210a samples the signal to generate digital data representative of the signal. Before the digital signal processor 210a prepares the digital data to be transmitted uphole, the transceiver 130b coupled to the uphole communication port 202a may detect communication activity in the portion of the drillstring telemetry channel located uphole of the repeater 126, thereby preventing the repeater 126 from transmitting uphole. As a result of the inability of the repeater 126 to transmit uphole, the digital signal processor 210a stores the digital data representative of the received operational data signal into the RAM portion of the memory 212a, which may periodically refresh the data as needed until, the transceiver 130b determines that the uphole portion of the drillstring telemetry channel is ready for transmission.

When an the uphole portion of the drillstring telemetry channel is ready (i.e., the repeater 126 can transmit uphole), the digital signal processor 210a retrieves the digital data representative of the received operational data signal from the RAM and converts the digital data, to an analog representation that is sent to the transceiver 130b coupled to the uphole communication port 202a via the equalizer 208b. The equalizer 208b performs signal processing on the analog representation according to the configuration of the equalizer 208b, which may be different than the configuration of the equalizer 208a. The transceiver 130b transmits the equalized analog signal through the uphole portion of the drillstring telemetry channel to another repeater (e.g., the repeater 128) coupled to the drillstring telemetry or communication channel. Thus, the repeater 126 can perform multiple signal processing operations or transmissions using different configurations to optimize transmission through different portions of the drillstring telemetry or communication channel.

As depicted in FIG. 2, the example signal processing system 200a also includes a power block 216a, which may regulate power provided by an external energy source such, as, for example, a battery pack. The regulated power output from the power block 216a supplies power to the other portions of the example signal processing system 200a such, as, for example, the transceivers 130a-b, the equalizers 208a-b, the digital signal processor 210a, etc. The example signal processing system 200a may also include one or more sensors 218a-b to measure environmental data associated with the environment surrounding the system 200a. More specifically, the sensors 218a-b may be used to measure temperature, pressure, vibration, shock and/or any other environmental conditions that may be appropriate and/or which may be useful to operators. Data collected by the sensors 218a-b may be input into the digital signal processor 210a for collection and storage in the memory 212a and/or transmittal to the surface computer 116.

The example signal processing system 200a also includes a serial communications interface 220a to facilitate programming of and/or access to data in the transceivers 130a-b, the equalizers 208a-b, the digital signal processor 210a, the memory 212a, the reference signal data 214a and/or the sensors 218a. The serial communications interface 220a may also be used to store or change configuration data sets in the memory 212a. The serial communications interface 220a may use serial protocols such as, for example, USB, RS-222, DH-422 or any other serial communication protocol. The serial communications interface 220a may be accessed, for example, when the repeater 126a is located at the surface 134. While the example signal processing system 200a is depicted as having the serial communications interface 220a, a wireless communications interface or a parallel communications interface could be used instead.

A power block 216b in the example telemetry module 118 may be similar or identical to the power block 216a in the example repeater 126. However, due to the difference of location between the telemetry modules 118 and 122 and the repeaters 126 and 128, the power block 216b may regulate power from a different type of power source than the power block 216a in the repeater 126. Similarly, one or more sensors 218c-d may be present in the example telemetry module 118 to provide data (e.g., conditions near the drill bit 112) to the digital signal processor 210b. Further, the example signal processing system 200b in the telemetry module 118 may include a serial communications interlace 220b similar or identical to the serial communications interface 220a in the example repeater 126.

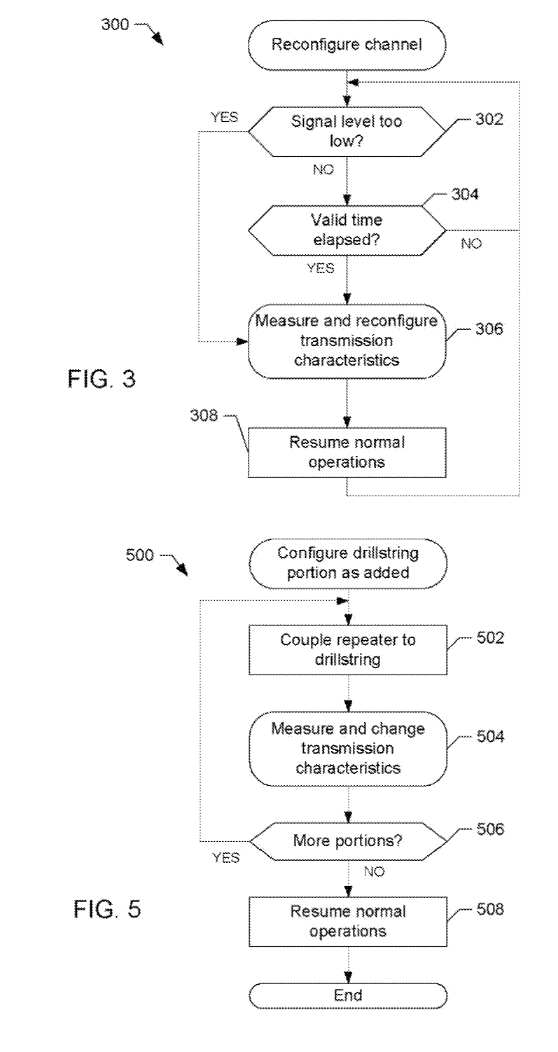

FIG. 3 is a flowchart representative of an example method 300 that may be used to reconfigure a downhole drillstring telemetry or communication channel such as that described in connection with the example of FIG. 1. Initially, the method 300 determines (e.g., via the digital signal processor 210a of the repeater 126) whether the signal quality in the drillstring telemetry or communication channel is below a minimum acceptable level (block 302). If the signal quality is acceptable, the method determines whether the current transmission configuration is valid based on the time elapsed since a previous configuration (block 304). If either the signal quality is below the minimum acceptable level (block 302) or a certain maximum amount of time has elapsed (block 304), the transmission characteristics of the drillstring telemetry channel are measured and reconfigured (block 306). If the signal level is not too low at block 302 and the certain time has not elapsed at block 304, control returns to block 302 to reevaluate the signal quality. After the transmission characteristics are measured and reconfigured, normal data operations (e.g., the transmission of operational data via the drillstring telemetry or communications channel) may resume (block 308) and control returns to block 302.

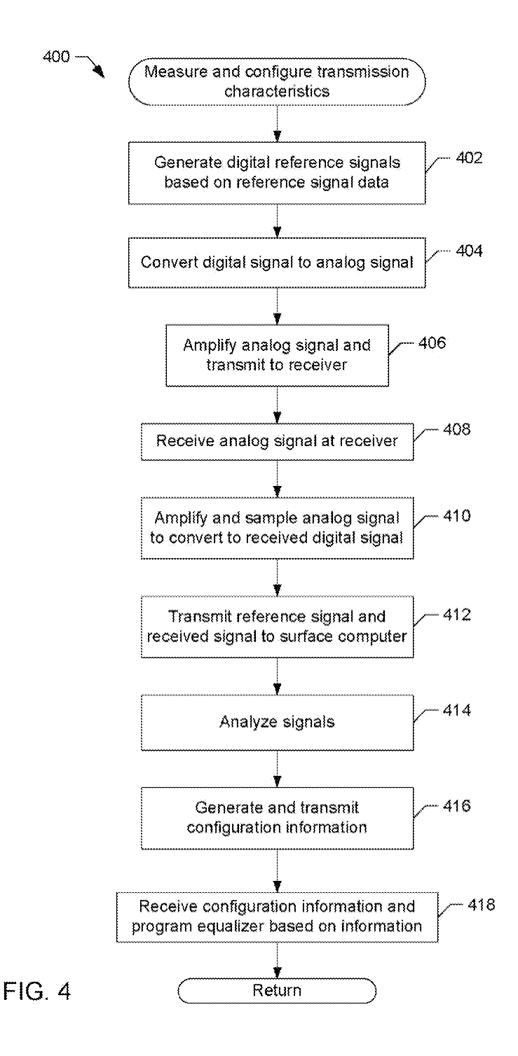

FIG. 4 is a more detailed flowchart representative of an example method 400 to measure and configure the transmission characteristics by which the operations performed at block 306 may be implemented. The example method 400 generates a digital signal (e.g., via. the digital signal processor 210a in the repeater 126) according to reference signal data (e.g., reference signal data 214a) stored in a memory (e.g., the memory 212a) (block 402). The signal is then converted to an analog signal (block 404) and amplified before being passed to the equalizer 208a, which may be programmed to not compensate for a previous frequency response of the drillstring telemetry channel. The method 400 then passes the analog signal to receiver (e.g., the transceiver 130a) (block 406).

It is noted that when configuring transmission characteristics, the previous response of a particular segment or of the whole channel may be used in determining the current response. In other examples, any previous responses may be ignored.

When received at the transceiver, the example method 400 transmits the analog signal via the drillstring telemetry or communications channel and the analog signals are received by a receiver (e.g., the transceiver 120b) (block 408). The analog signal is received and passed to the equalizer 208c, which may be programmed by the digital signal processor 210b to not compensate for a transmission characteristic of the drillstring telemetry channel. The signal may be amplified before sampling to generate another digital signal representing the received signal (block 410). The first digital signal representing the reference signal data and the second digital signal representing the received signal are then transmitted using any protocol to a surface computer (e.g., the surface computer 116) (block 412).

The reference signal and the received signal may be analyzed using signal analysis techniques such as, for example, energy estimation or correlation, to calculate one or more characteristics of the drillstring telemetry or communications channel (block 414). The method may calculate attenuation, phase shift, signal-to-noise ratio, a time- or frequency-varying characteristic, maximum data rate, optimal carrier frequency, or other relevant transmission characteristics.

An example analysis may be performed, on a sine wave. The attenuation through the channel may be measured by transmitting a single or multiple carrier sine wave over the drillstring telemetry channel and comparing the magnitude of each carrier in the frequency domain of the transmitted, and received signal(s) at a single frequency or multiple frequencies. The transmitted and received signals can be used to estimate how the drillstring telemetry channel changes over time within the frequency band near the carrier by doing energy estimation or correlation at the receiving repeater.

For example, a multiple carrier sine wave with frequencies f₁=50 kHz, f₂=100 kHz, and f₃=150 kHz may be measured according to the example method 400 as described above in blocks 402 through 414. By comparing the magnitude of each carrier in the transmitted and received signals, the surface computer can calculate the attenuation in the drillstring telemetry channel. The channel measurements are typically more accurate when there are more carriers in the signal. The manner in which the drillstring telemetry channel transmission characteristics vary over time may be measured by contiguously sending sine waves and analyzing the received signal.

It is noted that the response of a drillstring telemetry channel, or a portion thereof, may be different at different frequencies. Thus, the example methods described herein may be used to optimize all of the frequencies that are used on a particular channel. In another example, a particular frequency may be more important, and the optimization may be specific to that frequency, without optimizing the other frequencies that are used in the drillstring telemetry channel.

Another example analysis may be performed using a chirp signal. The transmitted chirp signal has a short-time Fourier transform that is substantially flat across the frequency domain. By sampling the received signal and taking a Fourier transform, the frequency response of the channel can be determined.

A third example analysis that may be performed by the surface computer uses quadrature phase-shift keying (QPSK) random bits. Unlike the sine wave and chirp signals, QPSK is spread out over time and frequency simultaneously. The spectrum of the signal may be determined by the symbol rate, center frequency, symbol pulse shape and randomness of the bits being sent. For example, a repeater may send a signal representing a sequence of pseudo-random bits that facilitates synchronization and regeneration for correlation-based channel estimation. Such sequences have a substantially flat frequency response and narrow autocorrelation, which may be useful for synchronization. The drillstring telemetry or communications channel is considered stationary when looking at a short window or segment of data, in which, case the drillstring telemetry channel may be estimated using a Wiener filter.

The example method 400 generates and transmits configuration information (e.g., a file sent via the surface computer 116) that may contain equalizer coefficients, channel characteristics, or other configuration information that may be used by signal processing systems (e.g., the signal processing systems 200a-b) associated with the measured drillstring telemetry channel (block 416). The configuration information may be used to reconfigure a repeater or a telemetry module. If it is known that the characteristics are the same for uphole and downhole communications of a drillstring telemetry channel, the configuration information may affect both the repeater and the telemetry module. The repeater and/or the telemetry module receive the configuration file and may change equalizer coefficients based on the information (block 418).

In another example, the reference signal data may be replaced by real-time operational data traveling uphole or downhole. As a repeater transmits operational data to a telemetry module, the repeater may store the digital data in its memory for subsequent transmission to the surface computer for comparison with the received data at the telemetry module.

FIG. 5 is a flowchart representative of an example method 500 to configure a portion of a drillstring telemetry or communications channel when the portion is added to the drillstring. The method 500 begins as a portion of the drillstring telemetry or communication channel such as, for example, a repeater is added to the drillstring. The repeater is coupled to the drillstring at the surface and is also communicatively coupled to the surface computer (block 502). When the repeater is coupled to the drillstring, the newly coupled portion of the drillstring telemetry channel is measured and configured (block 504). The operations of block 504 may be implemented using the example method 400 of FIG. 4. Once the portion of the drillstring telemetry channel is configured, control may return to block 502 if there is another portion of the drillstring telemetry channel to he added to the drillstring and configured (block 506). If there is no new portion of the drillstring telemetry channel to be configured (block 506), the drillstring may resume normal data operations (block 508).

It should be appreciated by those of skill that the methods described in connection with FIGS. 4-6 are not limited strictly to while-drilling applications. On the contrary, these methods may be adapted for additional applications such as well-testing or completions systems where a drillstring telemetry or communication channel exists in a wellbore.

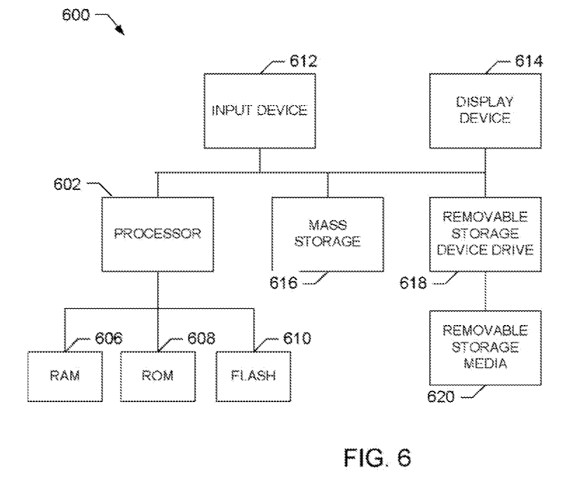

FIG. 6 is a block diagram of an example computing system 600 that may be used to implement the example methods and apparatus described herein. For example, the computing system 600 may be used to implement the above-described surface computer 116. The example computing system 600 may be, for example, a conventional desktop personal computer, a notebook computer, a workstation or any other computing device. A processor 602 may be any type of processing unit, such as a microprocessor from the Intel® Pentium® family of microprocessors, the Intel® Itanium® family of microprocessors, and/or the Intel XScale® family of processors. Memories 606, 608 and 610 that are coupled to the processor 602 may be any suitable memory devices and may be sized to fit the storage demands of the system 600. In particular, the flash memory 610 may be a non-volatile memory that is accessed and erased on a block-by-block basis.

An input device 612 may be implemented using a keyboard, a mouse, a touch screen, a track pad or any other device that enables a user to provide information to the processor 602.

A display device 614 may be, for example, a liquid crystal display (LCD) monitor, a cathode ray tube (CRT) monitor or any other suitable device that acts as an interface between the processor 602 and a user. The display device 614 as pictured in FIG. 6 includes any additional hardware required to interface a display screen to the processor 602.

A mass storage device 616 may be, for example, a conventional hard drive or any other magnetic or optical media, that is readable by the processor 602.

A removable storage device drive 618 may, for example, be an optical drive, such as a compact disk-recordable (CD-R) drive, a compact disk-rewritable (CD-RW) drive, a digital versatile disk (DVD) drive or any other optical drive, it may alternatively be, for example, a magnetic media drive. A removable storage media 620 is complimentary to the removable storage device drive 618, inasmuch as the media 620 is selected to operate with the drive 618. For example, if the removable storage device drive 618 is an optical drive, the removable storage media 620 may be a CD-R disk, a CD-RW disk, a DVD disk or any other suitable optical disk. On the other hand, if the removable storage device drive 618 is a magnetic media device, the removable storage media 620 may be, for example, a diskette or any other suitable magnetic storage media.

Although example methods, apparatus and articles of manufacture have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method to configure drillstring communications, comprising:
generating a signal at a transmitter coupled to a drillstring;
transmitting the generated signal via the transmitter to a receiver;
sampling the transmitted signal at the receiver to generate a received signal;
calculating a transmission characteristic based on a comparison of the generated signal and the received signal; and
configuring at least one of the transmitter or receiver based on the transmission characteristic.

2. A method as defined in claim 1, further comprising repeating the generating, transmitting, sampling, calculating and configuring in response to at least one of an elapsed time or a signal quality of the drillstring communications.

3. A method as defined in claim 1, further comprising repeating the sampling, calculating and configuring for each of a plurality of other transmitters and receivers spaced along the drillstring.

4. A method as defined in claim 3, wherein the repeating the sampling, calculating, and configuring for each of the plurality of the other transmitters and receivers spaced along the drillstring comprises configuring each of the transmitters and receivers once at the time the transmitters and receivers are coupled to the drillstring.

5. A method as defined in claim 1, wherein transmitting the generated signal to the receiver comprises transmitting the generated signal, uphole or downhole.

6. A method as defined in claim 1, wherein transmitting the generated signal to the receiver comprises transmitting an electrical signal via wired drill pipe, an acoustic signal, or an electromagnetic signal via the earth.

7. A method as defined in claim 1, wherein configuring at least one of the transmitter or receiver comprises sending configuration information to the at least one of the transmitter or receiver.

8. A method as defined in claim 1, wherein calculating a transmission characteristic comprises referring to a previous transmission characteristic.

9. A method as defined in claim 1, wherein configuring the at least one of the transmitter or receiver based on the transmission characteristic comprises changing a carrier frequency, a modulation, a bandwidth, or a channel equalization.

10. A method as defined in claim 1, wherein information associated with the transmitted signal and the received signal is sent to a surface computer, and wherein the surface computer performs the calculating of the transmission characteristic.

11. A method as defined in claim 1, wherein the generated signal is a reference signal.

12. A method as defined in claim 11, wherein the reference signal comprises at least one of a sine wave, a chirp signal, a quadrature phase-shift keying signal, or operational data.

13. A method as defined in claim 1, wherein calculating the transmission characteristic comprises calculating an attenuation, a phase shift, a signal-to-noise ratio, a time-varying characteristic, a frequency-varying characteristic, a maximum data rate, or an optimal carrier frequency.

14. A method as defined in claim 1, wherein calculating the transmission characteristic based on the comparison of the generated signal and the received signal comprises an energy estimation or a correlation.

15. A method as defined in claim 1, further comprising configuring at least another transmitter or receiver based on the transmission characteristic.

16. A method as defined in claim 1, wherein the receiver is coupled to the drillstring.

17. A system to configure drillstring communications, comprising;
a processing system having a memory and a processor configured to;
receive first information corresponding to a signal transmitted via a transmitter along a drillstring and second information corresponding to a receiver receiving the signal transmitted along the drillstring;
calculate a transmission characteristic of the drillstring communications based on a comparison of the first and second information; and
configure at least one of the transmitter or the receiver based on the transmission characteristic.

18. A system as defined in claim 17, wherein the processing system is a surface computer.

19. A system as defined in claim 17, wherein the processing system is to repeat the generating, transmitting, sampling, calculating and configuring in response to at least one of an elapsed time or a signal quality of the drillstring communications.

20. A system as defined in claim 17, wherein the processing system is to repeat the sampling, calculating and configuring for each of a plurality of other transmitters and receivers spaced along the drillstring.

21. A system as defined in claim 20, wherein the processing system is to repeat the sampling, calculating, and configuring for each of the plurality of the other transmitters and receivers spaced along the drillstring by configuring each of the transmitters and receivers once at the time it is coupled to the drillstring.

22. A method to configure drillstring communications, comprising:
generating a first signal at a first transmitter coupled to a first segment of a drillstring;
transmitting the first generated signal via the first transmitter to a first receiver at an opposite end of the first segment;
sampling the first transmitted signal at the first receiver to generate a first received signal;
calculating a first transmission characteristic of the first segment based on a comparison of the first generated signal and the first received signal;
generating a second signal at a second transmitter coupled to a second segment of the drillstring:
transmitting the second generated signal via the second transmitter to a second receiver at an opposite end of the second segment;
sampling the second transmitted signal at the second receiver to generate a second received signal;
calculating a second transmission characteristic of the second segment based on a comparison of the second generated signal and the second received signal;
generating a composite transmission characteristic based on the first transmission characteristic and the second transmission characteristic; and
configuring at least one of the second transmitter and the first receiver based on the composite transmission characteristic.

23. A method to configure drillstring communications, comprising:
step for generating a transmission signal;
step for receiving a received signal; and
step for generating a transmission characteristic based on a comparison of the transmission signal and the received signal.
